(19) United States
(12) Patent Application Publication
(10) Pub. No.: US 2025/0388141 A1
(43) Pub. Date: Dec. 25, 2025

(54) CUSHION FRAME

(71) Applicant: TOYOTA BOSHOKU KABUSHIKI KAISHA, Aichi (JP)

(72) Inventor: Yuki NAGATANI, Kasugai-shi (JP)

(73) Assignee: TOYOTA BOSHOKU KABUSHIKI KAISHA, Aichi (JP)

(21) Appl. No.: 19/239,627

(22) Filed: Jun. 16, 2025

(30) Foreign Application Priority Data
Jun. 21, 2024 (JP) 2024-100264

(51) Int. Cl. B60N 2/68; B60N 2/02; B60N 2/08; B60N 2/427

(52) U.S. Cl. CPC B60N 2/68; B60N 2/02246; B60N 2/08; B60N 2/42709; B60N 2002/022

(57) ABSTRACT

A cushion frame includes a first side frame; a second side frame; a coupling member; a first lifter link; a second lifter link; a lock mechanism; a first deformation inducer disposed in the first lifter link; and a second deformation inducer disposed in the second lifter link. A dimension from a rotation center of one end portion of the second lifter link to the second deformation inducer is greater than a dimension from a rotation center of one end portion of the first lifter link to the first deformation inducer.

### CROSS-REFERENCE TO RELATED APPLICATIONS

This application claims the benefit of Japanese Patent Application No. 2024-100264 filed on Jun. 21, 2024 with the Japan Patent Office, the entire disclosure of which is incorporated herein by reference.

### BACKGROUND

The present disclosure relates to a cushion frame that is used in a vehicle seat and that includes a function to displace the vehicle seat in up-down directions (hereinafter also referred to as “lifter function”).

For example, as shown in the Japanese Unexamined Patent Application Publication No. 2022-167380, the cushion frame at least includes two side frames (also referred to as “lower arms”) and a coupling pipe that couples the two side frames to each other.

The cushion frame that includes the lifter function further includes lifter links, a drive mechanism, and a lock mechanism. The lifter links are individually disposed on one end side and another end side of the coupling pipe in extending directions of the coupling pipe.

A lower end portion of each of the lifter links is rotatably and indirectly coupled to the vehicle via a sliding device. An upper end portion of each of the lifter links is integrated to the coupling pipe by welding or the like. In an electrically powered vehicle seat, an actuator, in which an electric motor and a reduction gear are integrated to each other, includes the drive mechanism and the lock mechanism.

### SUMMARY

In some cases, a deformation inducer such as a fragile portion is disposed in each lifter link in preparation for a case where a large external force is input to the vehicle seat. When a load that exceeds a preset magnitude acts on the cushion frame, the deformation inducer absorbs an energy generated by the load by plastically deforming before other parts of the cushion frame deform, thereby to inhibit large deformation of the other parts of the cushion frame.

However, it is difficult to have the lifter link, the displacement of which is directly restricted by the lock mechanism (hereinafter referred to as “restricted link”), and the lifter link, the displacement of which is indirectly restricted via the restricted link and the coupling pipe (hereinafter referred to as “free link”), cooperate with each other to properly cause deformation of the restricted link and the free link.

In other words, since the displacement of the restricted link is directly restricted by the lock mechanism, a reaction that acts on the restricted link against the input load is larger than a reaction that acts on the free link.

Accordingly, it is difficult to cause the restricted link and the free link to deform properly in cooperation with each other. The present disclosure discloses one example of a cushion frame in consideration of this problem.

A cushion frame that is used in a vehicle seat and that includes a function to displace the vehicle seat in up-down directions preferably includes at least one of the following elements, for example.

Such elements are, a first side frame extending in front-rear directions of the seat; a second side frame situated at a position distanced from the first side frame in seat-width directions, the second side frame extending in the front-rear directions of the seat; a coupling member extending in the seat-width directions and coupling the first side frame and the second side frame to each other, the coupling member being rotatable with respect to the first side frame and the second side frame; a first lifter link including one end portion that is rotatably and directly or indirectly coupled to a vehicle and an other end portion that is integrated to the coupling member on a side of the first side frame; a second lifter link including one end portion that is rotatably and directly or indirectly coupled to the vehicle and an other end portion that is integrated to the coupling member on a side of the second side frame, the second lifter link being configured to be displaced rotationally in synchronization with the first lifter link; a lock mechanism configured to restrict a rotational displacement of the first lifter link; a first deformation inducer disposed in the first lifter link, the first deformation inducer being configured to induce a deformation of the first lifter link when a load exceeding a preset magnitude acts on the first lifter link; and a second deformation inducer disposed in the second lifter link, the second deformation inducer being configured to induce a deformation of the second lifter link when a load exceeding a preset magnitude acts on the second lifter link.

A dimension from a rotation center of the one end portion of the second lifter link to the second deformation inducer is preferably greater than a dimension from a rotation center of the one end portion of the first lifter link to the first deformation inducer.

Accordingly, in this cushion frame, the first lifter link serves as the restricted link, and the second lifter link serves as the free link. In other words, the dimension from the rotation center of the one end portion of the free link to the second deformation inducer is greater than the dimension from the rotation center of the one end portion of the restricted link to the first deformation inducer.

A bending moment acting on the first deformation inducer is a product of multiplication between the dimension from the rotational center of the one end portion of the restricted link to the first deformation inducer and a force generated on the rotation center.

Likewise, a bending moment acting on the second deformation inducer is a product of multiplication between the dimension from the rotation center of the one end portion of the free link to the second deformation inducer and a force generated on the rotation center.

The force generated on the rotation center at each of the restricted link and the free link is a reaction against the input load. Accordingly, even when the reaction that acts on the free link is smaller than the reaction that acts on the restricted link, a difference between the magnitude of the bending moment that acts on the first deformation inducer and the magnitude of the bending moment that acts on the second deformation inducer is small. Thus, it may be possible to cause the restricted link and the free link to deform properly in coordination with each other.

The cushion frame may be configured as follows. That is, at least a part of a portion of the first lifter link ranging from the first deformation inducer to the coupling member preferably includes a sloping surface that slants with respect to the up-down directions so as to decline towards the second lifter link.

This makes it possible to assuredly plastically deform the first deformation inducer in a buckling manner.

The first deformation inducer preferably includes a curved portion so as to protrude towards the second lifter link. Furthermore, a bending rigidity of the second deformation inducer is preferably smaller than a bending rigidity of a portion of the second lifter link ranging from the rotation center of the one end portion of the second lifter link to the second deformation inducer.

### BRIEF DESCRIPTION OF THE DRAWINGS

An example embodiment of the present disclosure will be described hereinafter with reference to the accompanying drawings, in which:

FIG. 1 is a diagram showing a cushion frame according to a first embodiment;

FIG. 2 is a diagram showing the cushion frame according to the first embodiment;

FIG. 3 is a diagram showing a first lifter link according to the first embodiment;

FIG. 4 is a diagram showing a second lifter link according to the first embodiment;

FIG. 5 is a diagram showing the first lifter link according to the first embodiment;

FIG. 6 is a diagram showing a positional relationship between a first deformation inducer and a second deformation inducer; and

FIG. 7 is a diagram showing the positional relationship between the first deformation inducer and the second deformation inducer.

### DETAILED DESCRIPTION OF EXEMPLARY EMBODIMENTS

Following embodiments of the invention represent examples of embodiments that fall within the technical scope of the present disclosure. In other words, matters used to specify the invention or the like recited in the claims are not limited to any specific configuration, structure, or the like described in the following embodiments.

The present embodiments show examples where a cushion frame according to the present disclosure is applied to a seat provided to be mounted to a vehicle such as a car (hereinafter referred to as “vehicle seat”). Arrows for indicating directions, oblique lines, or the like in each drawing are used to facilitate understanding of mutual relations between the drawings, the shape of members or portions, or the like.

Therefore, orientation of the cushion frame is not limited to how the cushion frame is oriented in each drawing. The directions in each drawing are provided to show the orientation of the vehicle seat of the present embodiment when it is assembled to a car. A drawing with the oblique lines does not always represent a cross-sectional view.

With respect to at least a member or a portion explained with a reference numeral, at least one of such a member or a portion is disposed unless it is described using a term such as “only one of”. In other words, unless it is described using a term such as “only one of”, two or more of such a member or a portion may be disposed. The cushion frame of the present disclosure includes at least one of elements, such as at least a member or a portion explained with a reference numeral, or a structural component shown in the drawings.

### First Embodiment

### <1. Outline of Cushion Frame>

A cushion frame is a reinforcing member that serves as a framework of a seat cushion. The seat cushion is a portion for supporting buttocks of an occupant. The cushion frame according to the present embodiment includes a function to displace the seat cushion in up-down directions (hereinafter referred to as “lifter function”).

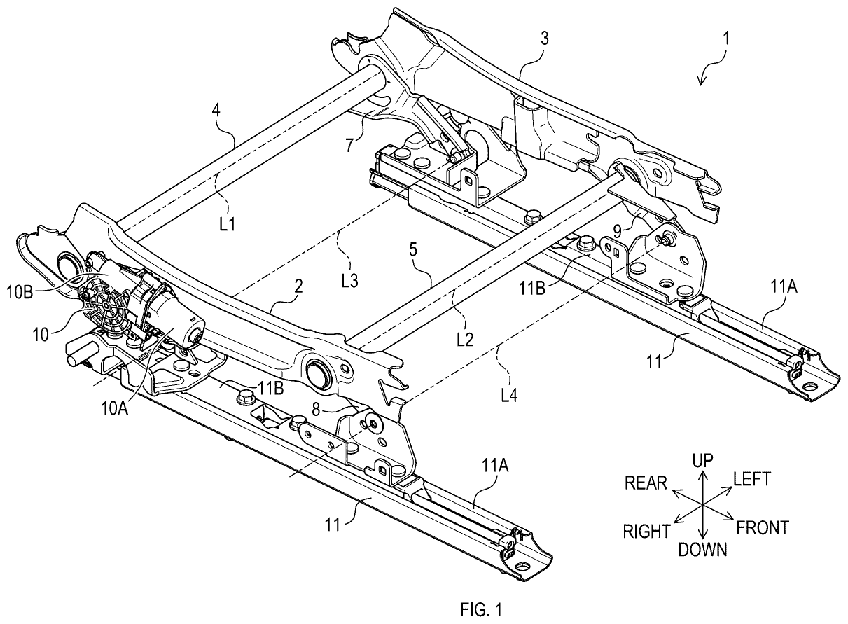

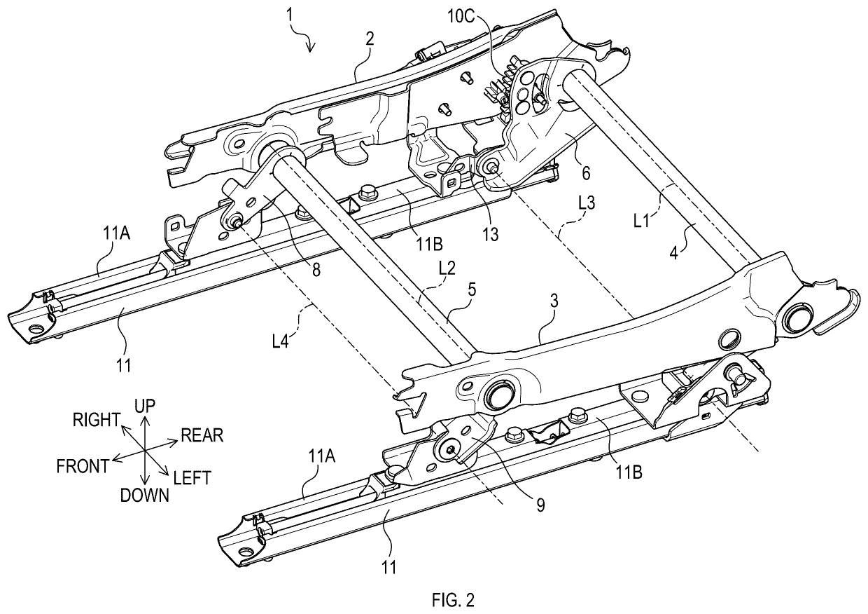

As shown in FIG. 1 and FIG. 2, a cushion frame 1 according to the present embodiment at least includes a first side frame 2; a second side frame 3; a first coupling pipe 4; a second coupling pipe 5; lifter links 6, 7, 8, 9; and an actuator 10.

The first side frame 2 and the second side frame 3 are lower arms extending in front-rear directions of the seat. The second side frame 3 is situated at a position distanced from the first side frame 2 in a seat-width direction (left direction).

The first coupling pipe 4 and the second coupling pipe 5 extend in seat-width directions (right-left directions) and couple the first side frame 2 and the second side frame 3 to each other. In other words, the first coupling pipe 4 is an example of a coupling member and couples a rear side portion of the first side frame 2 and a rear side portion of the second side frame 3 to each other.

The second coupling pipe 5 couples a front side portion of the first side frame 2 and a front side portion of the second side frame 3 to each other. The first coupling pipe 4 and the second coupling pipe 5 are rotatably coupled to the first side frame 2 and the second side frame 3 with center axes L1 and L2, respectively, being rotational center axes.

The lifter links 6 to 9 and the actuator 10 are functional parts for realizing the lifter function. Lower end portions of the lifters links 6 to 9 are rotatably and directly or indirectly coupled to the vehicle.

Specifically, the lower end portions of the lifter links 6 and 8 are indirectly coupled to the vehicle via a sliding device 11, and the lower end portions of the lifter links 7 and 9 are indirectly coupled to the vehicle via another sliding device 11. The two sliding devices 11 have the same structure. Each of the sliding devices 11 supports the cushion frame 1 so that the cushion frame can slide in the front-rear directions of the seat.

Each of the sliding devices 11 includes at least a fixed rail 11A and a movable rail 11B. The fixed rails 11A are fixed to the vehicle. Each of the movable rails 11B is slidably coupled to the corresponding one of the fixed rails 11A.

Each of the lower end portions of the lifter links 6 to 9 is rotatably coupled to the corresponding one of the movable rails 11B. Accordingly, the lifter links 6 and 7 can rotate with respect to their corresponding movable rails 11B about a rotational center axis L3 that is parallel to the rotational center axes L1 and L2. The lifter links 8 and 9 can rotate with respect to their corresponding movable rails 11B about a rotational center axis L4 that is parallel to the rotational center axes L1 and L2.

As shown in FIG. 2, an upper end portion of the lifter link 6 (hereinafter referred to as “first lifter link 6”) is integrated to the first coupling pipe 4 on the side of the first side frame 2. An upper end portion of the lifter link 8 is integrated to the second coupling pipe 5 on the side of the first side frame 2.

As shown in FIG. 1, an upper end portion of the lifter link 7 (hereinafter referred to as “second lifter link 7”) is integrated to the first coupling pipe 4 on the side of the second side frame 3. An upper end portion of the lifter link 9 is integrated to the second coupling pipe 5 on the side of the second side frame 3.

Thus, when the first coupling pipe 4 rotates, the first lifter link 6 and the second lifter link 7 are mechanically synchronized with the rotation and rotationally displaced. Likewise, the lifter links 8 and 9 are synchronized with the rotation of the second coupling pipe 5 and rotationally displaced.

The actuator 10 generates a driving force to rotate the first coupling pipe 4. Specifically, the actuator 10 is an electric motor in which an electric motor 10A and a reduction gear 10B are integrated.

The reduction gear 10B includes at least a worm (not illustrated) and a worm wheel (not illustrated). The worm is a gear that receives the driving force from the electric motor 10A and rotates. The worm wheel is a gear that meshes with the worm.

A rotational force output from the reduction gear 10B is transmitted to a sector gear 10C that is integrated to the first coupling pipe 4 (see FIG. 2). Thus, the first coupling pipe 4 rotates in response to an actuation of the electric motor 10A.

The sector gear 10C according to the present embodiment is integrated to the first lifter link 6. Thus, in the present embodiment, the rotational force transmitted to the sector gear 10C is then transmitted to the first coupling pipe 4 via the first lifter link 6.

Even in a case where the rotational force is input to an output side of the reduction gear 10B, in other words, even in a case where a force that rotates the first lifter link 6 or the first coupling pipe 4 is input to the output side of the reduction gear 10B by an external force, a rotor of the electric motor 10A does not rotate.

This is because the worm wheel cannot rotate the worm. In other words, the actuator 10 according to the present embodiment functions as “the lock mechanism that restricts the rotational displacement of the first lifter link 6”. Accordingly, in the cushion frame 1 according to the present embodiment, the first lifter link 6 serves as the restricted link, and the second lifter link 7 serves as the free link.

### <2. Details of First Lifter Link and Second Lifter Link>

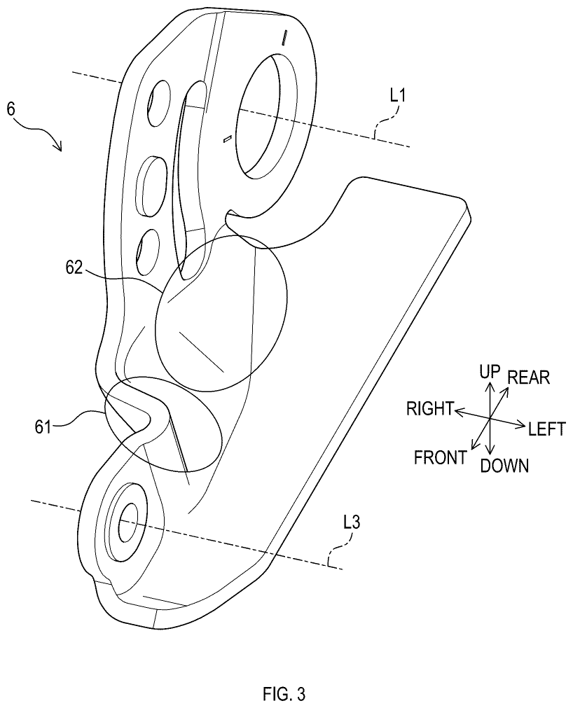

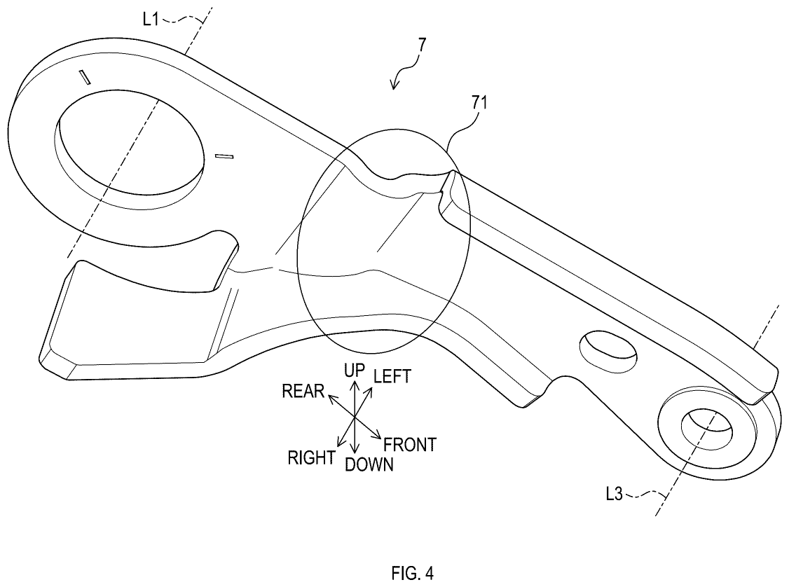

As shown in FIG. 3, the first lifter link 6 includes a first deformation inducer 61. As shown in FIG. 4, the second lifter link 7 includes a second deformation inducer 71.

The first deformation inducer 61 is a fragile portion where deformation of the first lifter link 6 is induced when a load that exceeds a preset magnitude acts on the first lifter link 6. In other words, the first deformation inducer 61 is a portion of the first lifter link 6 where rigidity is small and thus a stress is likely to be concentrated compared to the rest of the first lifter link 6.

Specifically, as shown in FIG. 3, the first deformation inducer 61 includes an approximately J-shaped or L-shaped curved portion so as to protrude towards the second lifter link 7 (left side in the present embodiment).

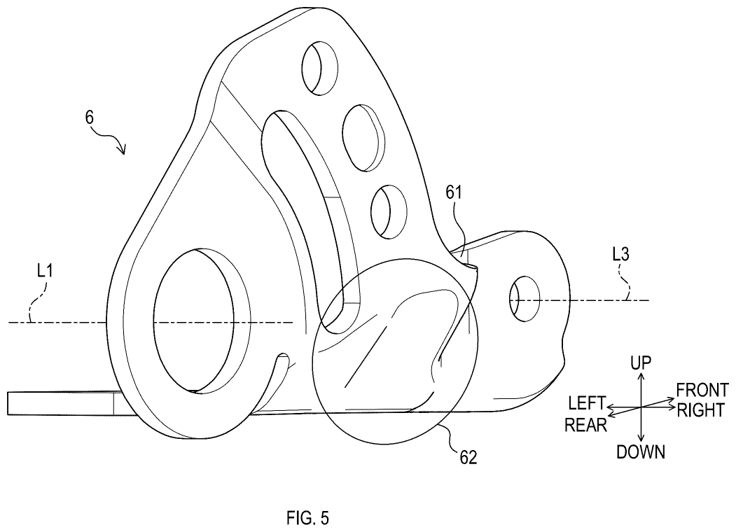

A portion of the first lifter link 6 ranging from the first deformation inducer 61 to the first coupling pipe 4 includes a sloping surface 62. As shown in FIG. 5, the sloping surface 62 slants with respect to the up-down directions so as to decline towards the second lifter link 7 (left side in the present embodiment) in a state where the cushion frame 1 is at its lowest position.

The second deformation inducer 71 is a fragile portion where deformation of the second lifter link 7 is induced when a load that exceeds a preset magnitude acts on the second lifter link 7. In other words, the second deformation inducer 71 is a portion of the second lifter link 7 where rigidity is small and thus a stress is likely to be concentrated compared to the rest of the second lifter link 7.

Specifically, as shown in FIG. 4, the second deformation inducer 71 is formed to have an approximately L-shaped cross-section. A portion of the second lifter link 7 ranging from the rotational center axis L3 to the second deformation inducer 71 (hereinafter referred to as “other portion”) is formed to have an approximately C-shaped cross-section or U-shaped cross-section with corners.

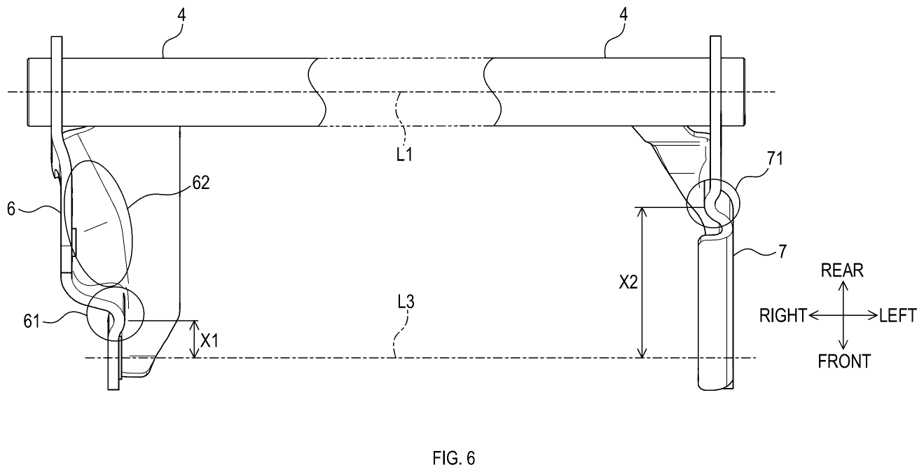

Accordingly, a bending rigidity of the second deformation inducer 71 is lower than that of the other portion. As shown in FIG. 6, the second deformation inducer 71 according to the present embodiment is distanced from the other portion (more specifically, from a flat plate portion in the other portion extending in the up-down directions) towards the first lifter link 6 (right side in the present embodiment).

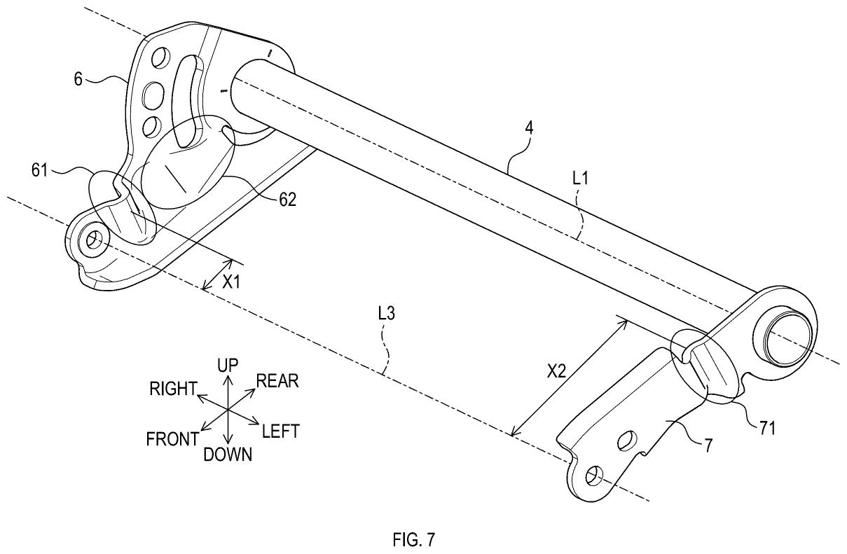

As shown in FIG. 7, a dimension X2 of the second lifter link 7, which is a dimension from the rotational center axis L3 to the second deformation inducer 71, is greater than a dimension X1 of the first lifter link 6, which is a dimension from the rotational center axis L3 to the first deformation inducer 61.

### <3. Characteristics of Cushion Frame of Present Embodiment>

A bending moment acting on the first deformation inducer 61 is a product of multiplication between the dimension X1, which is the dimension from the rotational center axis L3 of the first lifter link 6 to the first deformation inducer 61, and a force generated on the rotational center axis L3.

Likewise, a bending moment acting on the second deformation inducer 71 is a product of multiplication between the dimension X2, which is the dimension from the rotational center axis L3 of the second lifter link 7 to the second deformation inducer 71, and a force generated on the rotational center axis L3.

The force generated on the rotational center axis L3 at each of the first lifter link 6 and the second lifter link 7 is a reaction against a load input to the cushion frame 1 from outside. The dimension X2, which is the dimension from the rotational center axis L3 to the second deformation inducer 71, is greater than the dimension X1, which is the dimension from the rotational center axis L3 to the first deformation inducer 61.

Accordingly, even when a reaction that acts on the second lifter link 7 is smaller than a reaction that acts on the first lifter link 6, a difference between the magnitude of the bending moment that acts on the first deformation inducer 61 and the magnitude of the bending moment that acts on the second deformation inducer 71 is small. Thus, it may be possible to cause the first lifter link 6 and the second lifter link 7 to deform properly in coordination with each other.

At least a part of a portion of the first lifter link 6 ranging from the first deformation inducer 61 to the first coupling pipe 4 includes the sloping surface 62 that slants with respect to the up-down directions so as to decline towards the second lifter link 7.

This makes it possible to assuredly plastically deform the first deformation inducer 61 in a buckling manner. In other words, the first lifter link 6 is deformed in a buckling manner such that the distance between the rotational center axis L1 and the rotational center axis L3 is reduced.

At the time of this deformation, there is a risk that the first lifter link 6 may deform while being bent towards a side opposite from the second lifter link 7, that is, so as to shift towards the right side in the seat-width directions. In the present embodiment, as the deformation of the first lifter link 6 progresses, the sloping surface 62 comes in contact with a bracket 13 (see FIG. 2 etc.).

Thus, the direction of deformation of the first lifter link 6 is regulated to be guided by the sloping surface 62. Consequently, the deformation of the first lifter link 6 is inhibited from progressing towards the right side in the seat-width directions.

“The bracket 13” is a member for coupling the first lifter link 6 to the movable rail 11B. “The bracket 13 or the like” indicates the bracket 13 or a bolt or the like for fixing the bracket 13 to the movable rail 11B.

### Other Embodiments

In the aforementioned embodiment, the sloping surface 62 is situated in a portion of the first lifter link 6 ranging from the first deformation inducer 61 to the first coupling pipe 4. However, the present disclosure is not limited thereto. The sloping surface 62 may be situated in at least a part of a portion of the first lifter link 6 ranging from the rotational center axis L3 to the first coupling pipe 4.

The first lifter link 6 according to the aforementioned embodiment includes the sloping surface 62. However, the present disclosure is not limited thereto. In the present disclosure, for example, the first lifter link 6 does not have to include the sloping surface 62.

The first deformation inducer 61 according to the aforementioned embodiment includes an approximately J-shaped or L-shaped curved portion so as to protrude towards the second lifter link 7. However, the present disclosure is not limited thereto. In the present disclosure, for example, the first deformation inducer 61 may be formed in a manner similar to the second deformation inducer 71.

The second deformation inducer 71 according to the aforementioned embodiment is formed to have an approximately L-shaped cross-section. However, the present disclosure is not limited thereto. In the present disclosure, for example, the second deformation inducer 71 may be formed in a manner similar to the first deformation inducer 61.

The vehicle seat in the aforementioned embodiment includes the electric actuator 10 including the lock mechanism. However, the present disclosure is not limited thereto. The present disclosure may be applied to, for example, a manual vehicle seat that includes no electric motors.

The lock mechanism of the aforementioned embodiment is configured to use the reduction gear 10B disposed in the actuator 10. However, the present disclosure is not limited thereto. In the present disclosure, for example, a lock mechanism using a ratchet mechanism may be adopted.

In the aforementioned embodiment, the vehicle seat of the present disclosure is applied to a car. However, the application of the invention disclosed herein is not limited thereto. In other words, the present disclosure may be applied to a seat used in vehicles such as railroad vehicles, ships and boats, and aircrafts, and also to a stationary seat used in theaters and households, for example.

Furthermore, the present disclosure is only required to coincide with the gist of the disclosure described in the aforementioned embodiments and thus should not be limited to the aforementioned embodiments. Therefore, the present disclosure may include a configuration obtained by combining at least two of the aforementioned embodiments, or a configuration obtained by eliminating part of the elements in the drawings or the elements described with reference numerals in the aforementioned embodiments.

What is claimed is:

1. A cushion frame that is used in a vehicle seat and that includes a function to displace the vehicle seat in up-down directions, the cushion frame comprising:
a first side frame extending in front-rear directions of the seat;
a second side frame situated at a position distanced from the first side frame in seat-width directions, the second side frame extending in the front-rear directions of the seat;
a coupling member extending in the seat-width directions and coupling the first side frame and the second side frame to each other, the coupling member being rotatable with respect to the first side frame and the second side frame;
a first lifter link including one end portion that is rotatably and directly or indirectly coupled to a vehicle and an other end portion that is integrated to the coupling member on a side of the first side frame;
a second lifter link including one end portion that is rotatably and directly or indirectly coupled to the vehicle and an other end portion that is integrated to the coupling member on a side of the second side frame, the second lifter link being configured to be displaced rotationally in synchronization with the first lifter link;
a lock mechanism configured to restrict a rotational displacement of the first lifter link;
a first deformation inducer disposed in the first lifter link, the first deformation inducer being configured to induce a deformation of the first lifter link when a load exceeding a preset magnitude acts on the first lifter link; and
a second deformation inducer disposed in the second lifter link, the second deformation inducer being configured to induce a deformation of the second lifter link when a load exceeding a preset magnitude acts on the second lifter link,
wherein a dimension from a rotation center of the one end portion of the second lifter link to the second deformation inducer is greater than a dimension from a rotation center of the one end portion of the first lifter link to the first deformation inducer.

2. The cushion frame according to claim 1,
wherein at least a part of a portion of the first lifter link ranging from the first deformation inducer to the coupling member includes a sloping surface that slants with respect to the up-down directions so as to decline towards the second lifter link.

3. The cushion frame according to claim 2,
wherein the first deformation inducer includes a curved portion so as to protrude towards the second lifter link.

4. The cushion frame according to claim 3,
wherein a bending rigidity of the second deformation inducer is smaller than a bending rigidity of a portion of the second lifter link ranging from the rotation center of the one end portion of the second lifter link to the second deformation inducer.
